(19) United States
(12) Patent Application Publication
(10) Pub. No.: US 2026/0172883 A1
(43) Pub. Date: Jun. 18, 2026

(54) SYSTEM

(71) Applicant: Toyota Jidosha Kabushiki Kaisha, Toyota-shi (JP)

(72) Inventors: Shingo SUGIMOTO, Nagoya-shi (JP); Yuma Ito, Chiryu-shi (JP); Shigeo Ohnogi, Aichi-ken (JP); Isao Nishioka, Tokyo (JP); Naoki Ueda, Nisshin-shi (JP)

(73) Assignee: TOYOTA JIDOSHA KABUSHIKI KAISHA, Toyota-shi (JP)

(21) Appl. No.: 19/378,571

(22) Filed: Nov. 4, 2025

(30) Foreign Application Priority Data
Dec. 13, 2024 (JP) 2024-218990

(51) Int. Cl. H04W 28/02

(52) U.S. Cl. CPC H04W 28/0231

(57) ABSTRACT

The system includes an in-vehicle device and a server. The server stores communication performance information of one or more communication carriers transmitted from a plurality of vehicles. When a change in the vehicle state is detected, the in-vehicle device transmits information related to the change in the vehicle state to the server, and the server determines the communication requirement of the in-vehicle device based on the received information related to the change in the vehicle state, selects one of the communication carriers in which the communication requirement is satisfied from among the one or more communication carriers included in the communication result information as the specific carrier, and transmits the information of the selected specific carrier to the in-vehicle device. Then, the in-vehicle device connects to the specific carrier included in the received information.

### CROSS-REFERENCE TO RELATED APPLICATION

This application claims priority to Japanese Patent Application No. 2024-218990 filed on Dec. 13, 2024. The disclosure of the above-identified application, including the specification, drawings, and claims, is incorporated by reference herein in its entirety.

### BACKGROUND

### 1. Technical Field

The present disclosure relates to a system.

### 2. Description of Related Art

There is known a technique of selecting an optimum communication carrier from among a plurality of communication carriers. For example, Japanese Unexamined Patent Application Publication No. 2006-246409 (JP 2006-246409 A) discloses a technique of seamlessly switching a communication carrier even when a communication device having a roaming function moves overseas.

### SUMMARY

There is room for improvement in a technique of selecting an optimum communication carrier from a plurality of communication carriers.

The present disclosure can improve a technique of selecting an optimum communication carrier.

An aspect of the present disclosure provides
a system including an in-vehicle device and a server, in which:
   the server stores communication performance information of one or more communication carriers transmitted from a plurality of vehicles;
   when a change in a vehicle state is detected, the in-vehicle device transmits information relating to the change in the vehicle state to the server;
   the server
      determines a communication requirement of the in-vehicle device based on the received information relating to the change in the vehicle state,
      selects one of communication carriers satisfying the communication requirement, from among the one or more communication carriers included in the communication performance information, as a specific carrier, and
      transmits information on the selected specific carrier to the in-vehicle device; and
the in-vehicle device connects to the specific carrier included in the information.

According to the aspect of the present disclosure, a technique of selecting an optimum communication carrier is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block-diagram illustrating a schematic configuration of a system according to an embodiment of the present disclosure; and

FIG. 2 is a sequence diagram illustrating operation of a system according to an embodiment of the present disclosure.

### DETAILED DESCRIPTION OF EMBODIMENTS

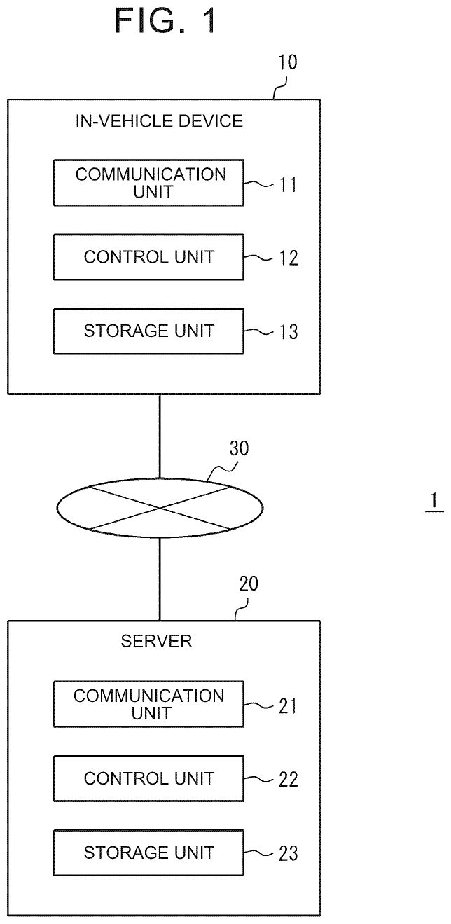

Hereinafter, an embodiment of the present disclosure will be described. As shown in FIG. 1, an outline of a system 1 according to an embodiment of the present disclosure will be described. The system 1 includes an in-vehicle device 10 and a server 20. When a change in the state of the vehicle on which the in-vehicle device 10 is mounted is detected, the server 20 selects an optimum communication carrier. The in-vehicle device 10 is, for example, an in-vehicle communication device, a navigation device, or the like, but is not limited thereto. The in-vehicle device 10 includes an eSIM. eSIM can store a communication profile associated with the communication carrier. The in-vehicle device 10 can use a mobile communication line provided by a communication carrier corresponding to such a communication profile. The server 20 is one or a plurality of computers that can communicate with each other, and can communicate with the in-vehicle device 10 via the network 30.

First, the outline of the present embodiment will be described, and the details will be described later. The system 1 includes an in-vehicle device 10 and a server 20. The server 20 stores communication result information of one or more communication carriers transmitted from a plurality of vehicles. When a change in the vehicle state is detected, the in-vehicle device 10 transmits the information to the server 20. The server 20 determines the communication requirement of the in-vehicle device 10 based on the received information related to the change in the vehicle state. Note that the server 20 selects one of the communication carriers that satisfy the communication requirement from among the one or more communication carriers included in the communication result information as the specific carrier, and transmits the information of the selected specific carrier to the in-vehicle device 10. Then, the in-vehicle device 10 connects to a specific carrier included in the information.

As described above, according to the present embodiment, in a country in which a plurality of communication carriers exist, the server 20 can select the optimum communication carrier suitable for the optimum communication condition based on the communication result information that the vehicle actually travels and accumulates. In addition, since the server 20 reselects the communication carrier when a change in the vehicle state is detected, an improvement in the communication environment, a reduction in the communication fee, and the like are expected. Therefore, a technique for selecting an optimum communication carrier is improved in that an optimum communication carrier is selected for the vehicle.

Next, each configuration of the system 1 will be described in detail.

As illustrated in FIG. 1, the in-vehicle device 10 includes a communication unit 11, a control unit 12, and a storage unit 13. The communication unit 11 includes one or more communication interfaces connected to the network 30. The communication interfaces correspond to mobile communication standards such as 5G (5th Generation), for example, but are not limited thereto. In the present embodiment, the in-vehicle device 10 communicates with the server 20 via the communication unit 11 and the network 30. The control unit 12 includes one or more processors, one or more dedicated circuits, or a combination thereof. The processor may be, but is not limited to, a general-purpose processor such as, for example, a CPU (Central Processing Unit), or a special-purpose processor specialized for a particular process. The control unit 12 controls the overall operation of the in-vehicle device 10. The storage unit 13 includes one or more memories. The memory is, for example, a semiconductor memory, a magnetic memory, or the like, but is not limited thereto. Each memory included in the storage unit 13 may function as, for example, a main storage device, an auxiliary storage device, or a cache memory. The storage unit 13 stores arbitrary information used for the operation of the server 20.

As illustrated in FIG. 1, the server 20 includes a communication unit 21, a control unit 22, and a storage unit 23. The hardware configurations of the communication unit 21, the control unit 22, and the storage unit 23 of the server 20 may be the same as the hardware configurations of the communication unit 11, the control unit 12, and the storage unit 13 of the in-vehicle device 10.

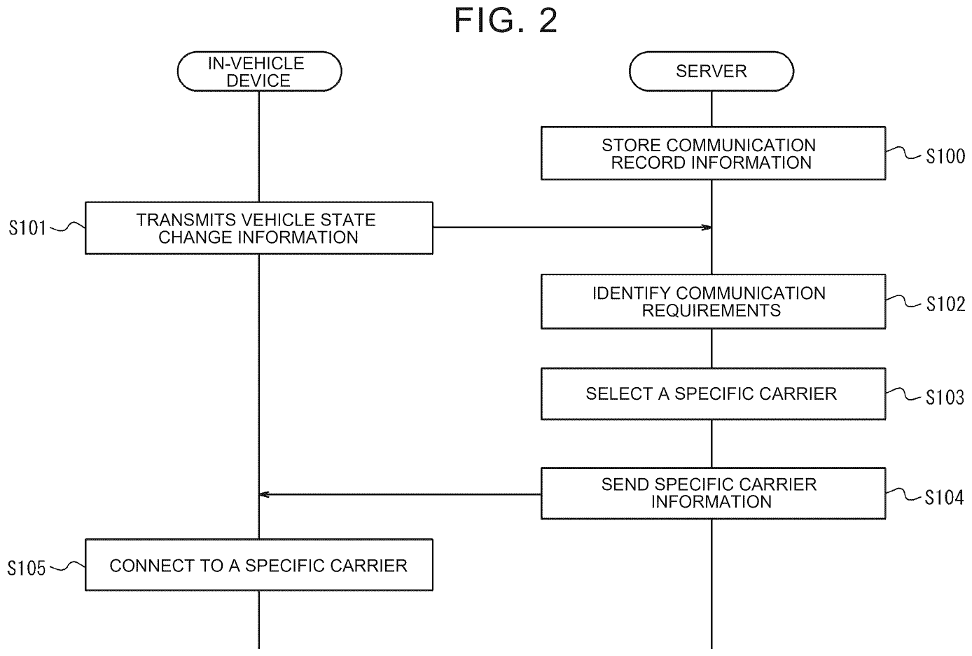

The operation of the system 1 according to the present embodiment will be described with reference to FIG. 2. The control unit 22 stores communication result data of one or more communication carriers transmitted from a plurality of vehicles in the storage unit 23 (S100). The communication result information of the communication carrier includes, for example, an evaluation item including at least one of a radio wave intensity from the base station for each area, a communication quality for each area, and a communication fee, and an evaluation result for each evaluation item, but is not limited thereto, and may include any information. The evaluation item may include information such as the number of base stations and the coverage area based on the public information of the plurality of communication carriers. Communication qualities may be assessed by any technique, such as, for example, SNR (Signal-to-Noise Ratio), CNR (Carrier-to-Noise Ratio), or CIR (Carrier-to-Interference Ratio). Other endpoints may also be evaluated in any manner.

When a change in the vehicle state is detected, the control unit 12 transmits information related to the change in the vehicle state to the servers 20 (S101). The change in the vehicle state includes, for example, but not limited to, a change in the destination, a change in the scheduled travel area, a change in the country or area during travel, or a change in the store storage state before the vehicle is sold to the user or a change to the market travel state after the vehicle is sold to the user. The information on the change of the destination and the change of the scheduled travel area is acquired from, for example, a car navigation system. The change of the country or the area while the vehicle is traveling is detected based on, for example, latitude and longitude information of the vehicle equipped with the in-vehicle device 10. The change to the store storage state or the market running state is detected, for example, when the vehicle is not operated for a certain period of time or when the vehicle is operated periodically. Further, the present disclosure is not limited to this, and a change in the vehicle state may be detected by an arbitrary method.

The control unit 22 determines S102 of the in-vehicle device 10 based on the received information about the change in the vehicle condition. The communication requirement is a requirement for a communication carrier after switching. Communication requirements include at least one of the first requirement, second requirement, third requirement, fourth requirement, and fifth requirement. The first requirement is that the radio wave intensity is stronger than that of the communication carrier before switching. The second requirement is that the communication quality is higher than that of the communication carrier before switching. The third requirement is that the communication cost is lower than that of the communication carrier before switching. The fourth requirement is that the number of base stations is larger than the number of communication carriers before switching. The fifth requirement is that the coverage area is larger than that of the communication carrier before switching. Here, the server 20 may store the public information of the plurality of communication carriers in the storage unit 23. The evaluation items according to the first requirement, the second requirement, and the third requirement (that is, the evaluation items of the strength of the radio wave intensity, the high communication quality, and the low communication cost) may be evaluated based on the communication result information. Evaluation items related to the fourth requirement and the fifth requirement (that is, evaluation items of the number of base stations and the width of the coverage area) may be evaluated based on the public information. For example, in a case where the market running state is changed to the store storage state, it is determined that the communication requirement includes the third requirement. Further, for example, when the traveling area is changed from the urban area to the mountainous area, it is determined that the communication requirement includes the first requirement.

In addition, the control unit 22 of the server 20 may store the vehicle model information of the vehicle equipped with the in-vehicle device 10 in the storage unit 23. In this case, the control unit 22 determines the communication requirement of the in-vehicle device 10 based on the change in the vehicle state and the vehicle model information. For example, when the vehicle is a family car having many opportunities to receive content via the network 30, the control unit 22 includes the third requirement in the communication requirement. Alternatively, in the case of a sports car in which the vehicle has less opportunity to communicate, the control unit 22 includes the first requirement or the second requirement in the communication requirement. As a result, the control unit 22 can determine the communication requirements in consideration of the suitability for each vehicle model, which leads to an improvement in usability.

The control unit 22 selects one of the communication carriers that satisfy the communication requirement from among the one or more communication carriers included in the communication result information as the specified carrier (S103). Here, in a case where the specified communication requirement includes the first requirement, the second requirement, or the third requirement, the control unit 22 identifies, as a candidate, each communication carrier in which the communication requirement is satisfied from among the one or more communication carriers based on the communication result information. In addition, when the specified communication requirement includes the fourth requirement or the fifth requirement, the control unit 22 identifies each communication carrier in which the communication requirement is satisfied from among the one or more communication carriers as a candidate based on the public information. The control unit 22 selects a specific carrier from among the one or more identified candidates based on the evaluation result for each evaluation item included in the communication result information. For example, RSSI (Received Signal Strength Indicator) may be determined based on the measurement result of the radio wave strength that is the evaluation item according to the first requirement. The evaluation result of the communication quality, which is the evaluation item according to the second requirement, may be determined based on SNR value. The evaluation result of the communication cost, which is an evaluation item according to the third requirement, may be determined by comparison with an average value of communication charges per packet of a plurality of communication carriers in the same country. The evaluation result of the number of base stations, which is an evaluation item according to the fourth requirement, may be determined by comparison with an average value of the number of base stations of a plurality of communication carriers in the same country. Further, the evaluation item according to the fifth requirement may be determined by comparison with an average value of area coverage rates of a plurality of communication carriers in the same country.

Here, in S103 selection process, when there are a plurality of communication carrier candidates, the communication carrier having the highest overall rating may be selected as the specific carrier from among the communication carriers that satisfy the communication requirement. The overall evaluation value is a value obtained by comprehensively determining the evaluation item of the communication carrier. In addition, a machine learning model may be used as appropriate in the calculation of the individual evaluation value. In this case, the server 20 may store, in the storage unit 23, the machine learning model trained using the evaluation item included in the communication result information as the feature amount. Specifically, the control unit 22 inputs the evaluation items included in the communication result information into the machine learning model to determine the individual evaluation values. The individual evaluation value is an evaluation value determined for each evaluation item of each communication carrier according to the communication requirement. Further, the control unit 22 determines an overall evaluation value for each communication carrier based on the determined individual evaluation value. The control unit 22 selects, as the specific carrier, a communication carrier having the highest overall evaluation value among the communication carriers that satisfy the communication requirements. The overall evaluation value may be determined by any statistical method, such as, for example, a total value of all individual evaluation values, an average value of all individual evaluation values, and a total value of individual evaluation values having a high priority.

The control unit 22 transmits information of the selected particular carrier to the in-vehicle device 10 via the network 30 (S104). The specific carrier information includes, for example, information indicating a specific carrier, a communication profile for using a mobile communication line provided by the specific carrier, and the like, but is not limited thereto, and may include any information regarding the specific carrier. Note that the server 20 may store in advance a communication profile corresponding to each communication carrier, or may acquire the communication profile from the communication carrier each time.

The in-vehicle device 10 connects to a particular carrier included in the received data (S105). The in-vehicle device 10 extracts a communication profile from information received from the server 20 via the network 30. The in-vehicle device 10 overwrites the communication profile stored in eSIM with the communication profile received from the servers 20, and connects using the communication profile. Thereafter, the in-vehicle device 10 can communicate with the mobile communication line provided by the specific carrier. In this way, switching (carrier swap) from the communication carrier A to the communication carrier B is performed.

Although the present disclosure has been described above based on the drawings and the embodiment, it should be noted that those skilled in the art may make various modifications and alterations thereto based on the present disclosure. It should be noted, therefore, that these modifications and alterations are within the scope of the present disclosure. For example, the functions included in the configurations, steps, etc. can be rearranged so as not to be logically inconsistent, and a plurality of configurations, steps, etc. can be combined into one or divided.

For example, in the above-described embodiment, the configuration and operation of the server 20 may be distributed among a plurality of computers capable of communicating with each other. For example, an embodiment in which some or all of the components of the server 20 are provided in the in-vehicle device 10 is also possible.

In the above-described embodiment, there is a case where the server 20 transmits an emergency notification to the in-vehicle device 10 or a case where a notification that an emergency notification is transmitted from the in-vehicle device 10 is received. In this case, the communication requirement may be identified as the first requirement regardless of whether there is a change in the vehicle state. The emergency notification refers to, for example, a notification in the event of an accident or an emergency disease, but the present disclosure is not limited thereto and may be any content.

What is claimed is:

1. A system comprising an in-vehicle device and a server, wherein:
the server stores a machine learning model and communication performance information of one or more communication carriers transmitted from a plurality of vehicles;
when a change in a vehicle state indicating a state of a vehicle on which the in-vehicle device is mounted is detected, the in-vehicle device transmits information relating to the change in the vehicle state to the server;
the server
determines a communication requirement of the in-vehicle device based on the received information relating to the change in the vehicle state,
determines an individual evaluation value by inputting, to a machine learning model trained using an evaluation item included in the communication performance information as a characteristic quantity, the evaluation item included in the communication performance information,
determines an overall evaluation value for each communication carrier based on the determined individual evaluation value,
selects a communication carrier with a highest overall evaluation value, among communication carriers satisfying the communication requirement, as a specific carrier, and
transmits information on the selected specific carrier to the in-vehicle device; and
the in-vehicle device connects to the specific carrier included in the information.

2. A system comprising an in-vehicle device and a server, wherein:
the server stores communication performance information of one or more communication carriers transmitted from a plurality of vehicles;
when a change in a vehicle state is detected, the in-vehicle device transmits information relating to the change in the vehicle state to the server;
the server
determines a communication requirement of the in-vehicle device based on the information relating to the change in the vehicle state,
selects one of communication carriers satisfying the communication requirement, from among the one or more communication carriers included in the communication performance information, as a specific carrier, and
transmits information on the selected specific carrier to the in-vehicle device; and
the in-vehicle device connects to the specific carrier included in the information.

3. The system according to claim 2, wherein:
the server further stores public information on a plurality of communication carriers;
the communication requirement includes one or more of a first requirement of offering a radio wave intensity higher than that of a communication carrier before switching, a second requirement of offering a communication quality higher than that of the communication carrier before switching, a third requirement of offering a communication cost lower than that of the communication carrier before switching, a fourth requirement of offering a number of base stations larger than that of the communication carrier before switching, and a fifth requirement of offering a coverage area wider than that of the communication carrier before switching; and
the in-vehicle device
specifies, when it is determined that the communication requirement includes the first requirement, the second requirement, or the third requirement, communication carriers satisfying the communication requirement, from among the one or more communication carriers, as candidates based on the communication performance information,
specifies, when it is determined that the communication requirement includes the fourth requirement or the fifth requirement, communication carriers satisfying the communication requirement, from among the one or more communication carriers, as candidates based on the public information, and
selects the specific carrier from among one or more specified candidates.

4. The system according to claim 2, wherein the server
further stores vehicle model information on a vehicle on which the in-vehicle device is mounted, and
determines the communication requirement of the in-vehicle device based on the received change in the vehicle state and the vehicle model information.

5. The system according to claim 2, wherein when an emergency notification is transmitted to the in-vehicle device or when a notification that the emergency notification is transmitted from the in-vehicle device is received, the server specifies the communication requirement as a first requirement of offering a radio wave intensity higher than that of a communication carrier before switching, regardless of whether there is any change in the vehicle state.
